(19) United States
(12) Patent Application Publication
(10) Pub. No.: US 2024/0351135 A1
(43) Pub. Date: Oct. 24, 2024

(54) METHOD FOR SIZING STUBS OF A BLADE DISC OF A TURBOMACHINE INTENDED FOR ORBITAL WELDING

(71) Applicant: SAFRAN AERO BOOSTERS, HERSTAL (BE)

(72) Inventor: Johann PANCRACE, HERSTAL (BE)

(21) Appl. No.: 18/640,473

(22) Filed: Apr. 19, 2024

(30) Foreign Application Priority Data
Apr. 21, 2023 (BE) 2023/5296

(51) Int. Cl. B23K 20/12; B23K 101/00; F01D 5/30

(52) U.S. Cl. CPC B23K 20/129; F01D 5/3061; B23K 2101/001; F05D 2230/239

(57) ABSTRACT

A method for sizing a junction section by orbital friction welding between a blade and a stub of a bladed disk for a turbomachine. The section is sized such that the ratio of an average ray length extending fully into the section from a point at the periphery of said section and sweeping across said section, where said average ray length is a maximum average length, and an average length of rays extending completely into the section from another point at the periphery of said section and sweeping through said section, where said average length is a minimum average length, is less than or equal to 2.

### TECHNICAL AREA

The invention relates to a method of manufacturing a bladed disk for a turbomachine, and more particularly to a method of manufacturing a bladed disk by orbital friction welding of blades to a rotor disk of a turbomachine. The invention also relates to a method of forming stubs as well as a blade and a rotor disk comprising a stub formed by said method.

### PRIOR ART

Climate change is a major concern for many legislative and regulatory bodies around the world. Indeed, various restrictions on carbon emissions have been, are or will be adopted by various states. In particular, an ambitious standard applies both to new types of aircraft but also to those in circulation requiring the implementation of technological solutions in order to make them comply with current regulations. Civil aviation has been mobilizing for several years now to make a contribution to the fight against climate change.

Technological research efforts have already made it possible to very significantly improve the environmental performance of aircraft. The Applicant takes into consideration the impacting factors in all phases of design and development to obtain aeronautical components and products that consume less energy, are more respectful of the environment and whose integration and use in civil aviation have moderate environmental consequences with the aim of improving the energy efficiency of aircraft.

Consequently, the Applicant is constantly working to reduce its negative climate impact through the use of methods and the exploitation of virtuous development and manufacturing processes and minimizing greenhouse gas emissions to the minimum possible for reduce the environmental footprint of its activity.

This sustained research and development work concerns new generations of aircraft engines, the reduction of aircraft weight, particularly through the materials used and lightweight on-board equipment, and the development of the use of electrical technologies to ensure propulsion, and, essential complements to technological progress, aeronautical biofuels.

To this end, the invention is the result of technological research aimed at very significantly improving the performance of aircraft and, in this sense, contributes to reducing the environmental impact of aircraft.

In this context, the invention relates to an orbital friction welding process for producing a bladed disk (commonly referred to as: “blisk”) or a bladed drum (commonly referred to as “blum”) of a turbomachine compressor.

Orbital friction welding is a welding process in which the parts to be assembled are brought into contact under force and welded by a circular movement generally defined by an eccentric, and accompanied by a uniform tangential speed, so as to generate a friction and homogeneous heating at the level of a weld junction between the two parts.

It is also known to use linear friction welding, this is a welding process in which the necessary heat is created by a back and forth movement of the interfaces to be welded. However, orbital friction welding has several advantages over linear friction, for example, the relative movement between the two interfaces is continuous thanks to the circular friction movement, which provides better thermal homogeneity. Unlike linear movement for which the relative speed of the two parts becomes zero at each half-period of oscillation. In addition, the cycle time of orbital welding is considerably lower than that of linear friction welding (respectively about 2 minutes compared to about 5 minutes).

The published patent document EP 2 535 516 A1 discloses a process for orbital friction welding of blades to a turbomachine rotor in which, once a material consumption is reached in a welding zone between the blade and the disk, the orbital movement is stopped at a reference position, and a forging force is exerted on the blade against the rotor in order to finalize the weld.

After welding, progressive machining adapting to the external surface of the blade is then carried out in order to remove the material from the interface which will have been pushed out from the outside during welding (commonly referred to as: “flash”), so as to avoid any jump linked to machining.

However, welding may reveal a welded joint of the blade with the rotor disk which may present structural defects and/or material health defects.

The published patent document EP 1 495 829 A1 discloses a process for manufacturing combined profiled blades and discs, in which each of the blades has a stub to be welded to the disc by linear friction. The document proposes a design of the stub including a ratio of the widest part to the narrowest part of said stub which is less than 2 to minimize its camber. The document also proposes a particular shape at the ends of the stub which follows a tangential direction of linear oscillation during linear friction welding.

However, the stub design proposed by the paper has room for improvement, as it cannot be applied to orbital welding. Indeed, such a stub does not make it possible to obtain a welded junction by orbital welding which is healthy and free of contaminants.

### SUMMARY OF THE INVENTION

### Technical Problem

The invention aims to solve at least one of the problems posed by the prior art. More precisely, the invention aims to propose a junction section of a blade and a disc stub making it possible to control and optimize orbital welding in order to obtain a healthy welded junction free of contaminants.

### Technical Solution

The subject of the present invention is a method for sizing a junction section by orbital friction welding between a blade and a stub of a bladed disk for a turbomachine, wherein the section is sized so that the ratio between an average length of rays extending completely into the section from a point at the periphery of said section and sweeping across said section, where said average length of rays is a maximum average length zₘₐₓ, and an average length of rays extending totally in the section from another point at the periphery of said section and sweeping said section, where said average length is a minimum average length zₘᵢₙ, is less than or equal to 2.

According to an advantageous embodiment of the invention, the other point at the periphery of the section where the average length of rays is maximum zₘₐₓ is located at a distance from two ends of the section, along a chord of the corresponding blade, and corresponding to a leading edge and a trailing edge of said corresponding blade.

According to an advantageous embodiment of the invention, the point at the periphery of the section where the average length of rays is minimum z ₘᵢₙ is located at one end of the section, along a chord of the corresponding blade and corresponding to an edge d attack or at a trailing edge of said corresponding blade.

According to an advantageous embodiment of the invention, the section of the stubs at the junction with the blades is sized by widening said section relative to a final section after joining the blades and machining.

According to an advantageous embodiment of the invention, the section of the stubs at the junction with the blades is widened relative to the final section at at least one of the two ends of the section.

Alternatively, the section of the stubs at the junction with the blades is widened relative to the final section to a central portion between a leading edge and a trailing edge of the blades, at the level of a concave portion of the section.

According to an advantageous embodiment of the invention, the sizing of the section of the stubs at the level of the junction with the blades comprises a calculation of the average length of rays for a series of points distributed along the periphery, respectively and a determination of the maximum average ray length z ₘₐₓ and the minimum average ray length z ₘᵢₙ among the average ray lengths of the series of points.

According to an advantageous embodiment of the invention, the sizing of the section of the stubs at the junction with the blades comprises a determination of the maximum average rays length z ₘₐₓ and the minimum average rays length z min for different sections, iteratively.

The invention also relates to a method of manufacturing a bladed turbomachine disk comprising the following steps: providing a disk with stubs; joining of blades to the stubs by orbital friction welding; wherein the stubs of the disc are sized according to the sizing method according to the invention.

According to an advantageous embodiment of the invention, the stubs are sized according to the sizing method of the invention and comprising the additional step: machining of the stubs and the blades joined to the stubs so as to remove the widening and arrive at the section final.

The invention also relates to a rotor disk intended for the manufacture of a bladed disk for a turbomachine, the rotor disk comprising an external surface provided with an annular row of stubs extending radially from said external surface, each of the stubs comprising a section intended to be welded by orbital friction with a blade, wherein said stubs are sized by the sizing method according to the invention.

According to an advantageous embodiment of the invention, the section is between 200 mm² and 7000 mm².

According to an advantageous embodiment of the invention, the section is between 2000 mm² and 3000 mm².

The invention also relates to a blade intended for the manufacture of a bladed disk for a turbomachine, the blade comprising a face intended to be welded by orbital friction with a rotor disk, wherein said face has a section sized by the sizing method according to the invention.

According to an advantageous embodiment of the invention, the section is between 200 mm² and 7000 mm².

According to an advantageous embodiment of the invention, the section is between 2000 mm² and 3000 mm².

The measures of the invention are advantageous in that the dimensioning of the junction section while respecting the ratio of the maximum average length Z ₘₐₓ to the minimum average length z ₘᵢₙ which is less than or equal to 2, makes it possible to guarantee a surface of contact during welding ensuring better homogeneity of the mixing of the material, resulting in a resistant and more robust weld.

Indeed, the evolution of the rays extending and completely sweeping the section to be welded from a point at its periphery, physically represents the homogeneity of the length to be sheared during the orbital movement and therefore the homogeneity of the flow of material expelled in the flash along the outline of the dawn. It is representative of the homogeneity of ejection of contaminants from the weld.

In addition, the stub dimensioned by the method of the invention includes improved stiffness.

It is understood that each detail of an embodiment below may be combined with each other detail of the other embodiments.

### BRIEF DESCRIPTION OF THE DRAWINGS

FIG. 1 illustrates a rotor disk comprising a stub extending radially from an external surface of said disk, and a blade comprising a face having a junction section intended to be welded by orbital friction to the stub of the disk;

FIG. 2 schematically illustrates a first modeled section of the blade and/or the stub intended to be dimensioned to form the junction section visible in FIG. 1;

FIG. 3 illustrates the first modeled section of FIG. 2 during a determination of an average length z _{A} of rays z _{A, α} sweeping said section from a point A of the periphery of said section;

FIG. 4 illustrates the first modeled section of FIG. 2 during a determination of an average length z _{B} of rays z _{B, α} sweeping said section from a point B of the periphery of said section;

FIG. 5 illustrates a second modeled section, resulting from an enlargement to the right of the ends of the first modeled section of FIG. 2;

FIG. 6 illustrates an alternative of the second modeled section, resulting from an enlargement to the right of a concave portion of the first modeled section of FIG. 2;

FIG. 7 schematically represents a perspective view, during orbital friction welding, of the blade to the stub of the disc, by means of the junction section;

FIG. 8 represents three models of different sections including excess material presented around an aerodynamic profile of a blade which is not shown;

FIG. 9 represents relative movements of two sections of the prior art comprising a surplus of material forming a right angle parallel to the direction of oscillation during linear friction welding;

FIG. 10 represents relative movements of two sections according to the invention during orbital friction welding;

FIG. 11 illustrates a graph indicating, for different values of the ratio zₘₐₓ/zₘᵢₙ, the evolution of the contaminant particles at the initial contact surfaces during the orbital welding between the blade and the corresponding disc stub, depending on material consumption during said orbital welding.

### DETAILED DESCRIPTION OF THE EMBODIMENTS

In the description which follows, the terms “internal” and “external” refer to a positioning relative to the axis of rotation of an axial turbomachine and/or to a central axis of a bladed rotor disk. The axial direction corresponds to the direction along the axis of rotation of the turbomachine, the lengths being measured axially. Widths are measured according to circumference. The radial direction is perpendicular to the axis of rotation. Upstream and downstream refer to the main flow direction of the flow in the turbomachine.

The dimensions of the figures are not to scale and in particular the thicknesses or the radial dimensions are exaggerated to facilitate the reading of the figures.

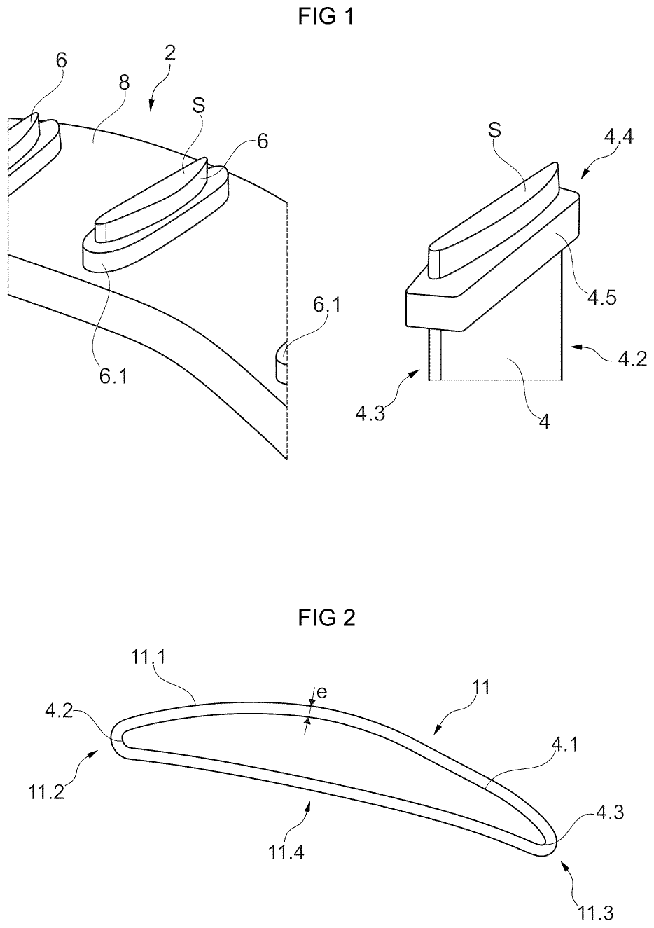

FIG. 1 illustrates a rotor disk 2 comprising a stub 6 extending radially from an external surface 8 of said disk 2, and a blade 4 comprising a face S having a junction section S intended to be welded by orbital friction to the stub 6 of the disc 2, and precisely welded to an identical junction section S of said stub 6. The two junction sections S are flat. Orbital friction welding will be explained later in this description.

The rotor disk 2 comprises an annular row of stubs 6 intended to be welded with corresponding blades 4, so as to form a bladed turbomachine disk. Each blade 4 comprises a lower end 4.4 having a shape identical to the stub 6 of the disc 2. It is therefore generally considered that the blade 4 comprises a stub at its lower end 4.4. Preferably, the bladed disk is a mobile wheel intended to be placed upstream of an air flow separation nozzle in the turbomachine. For this purpose, the external surface 8 corresponds to an air guiding surface of a stream of fluid along and through a rotor. Alternatively, the blisk may correspond to a drum-type rotor belonging to a high-pressure or low-pressure compressor.

Preferably, the bladed disk is a so-called “bi-material” disk comprising two different titanium alloys. For example, the blades 4 can be manufactured from a Ta6v alloy, and the rotor disk 2 from one of the following alloys: Ti17, Ti575, Ti1023.

Advantageously, the mixture of the two different titanium alloys (Ta6v and Ti17) presents easier machinability, and makes it possible to achieve a gain in mass compared to a solution based, for example, solely on a Ti17 alloy, this is notably due to a density of Ta6v which is slightly lower than that of Ti17.

Indeed, the Ti17 alloy was preferentially chosen for the disc part for its good fatigue characteristics HCF (English acronym for: “High Cycle Fatigue”) and LFC (“Low Cycle Fatigue”). A Ti17 disc will also show a greater margin in burst speed than a Ta6v disc. For the blades, the Ta6v alloy was chosen because it provides the blades with a higher elongation at break (better resistance to impacts), and better crack propagation behavior which results in better durability to low energy impacts.

In the configuration illustrated in FIG. 1, the blade 4 is illustrated in a radial direction opposite to that during welding in order to better visualize the junction section S at the foot of said blade 4.

Preferably, the stub 6 also has the junction section S which is identical to that of the blade 4. Advantageously, the section S is dimensioned according to a stub sizing process which will be explained according to FIGS. 2 to 5.

FIG. 2 schematically illustrates a first modeled section 11 of the blade and/or the stub intended to be dimensioned to form the junction section S visible in FIG. 1.

The dimensioning of the junction section is carried out following the method of dimensioning the stubs which preferably comprises a first step of modeling a first section 11 from an aerodynamic profile 4.1 of the blade, said profile 4.1 corresponds to the final profile of the dawn after machining.

Preferably, the first section 11 comprises a widening of the profile 4.1 by means of an extra thickness e corresponding, preferably, to an eccentric e of the orbital oscillation movement during orbital friction welding. The eccentric e corresponds to the offset value of the tool (maintaining the blade) and the disk relative to a reference center, making it possible to create the orbital oscillation movement. In other words, the eccentric corresponds to the distance between the axis of rotation of the tool and the central point around which it performs its orbital movement.

The illustration of section 11 is schematic, the extra thickness e is not necessarily constant around profile 4.1, it can present variations around said profile 4.1.

The method for sizing the stubs comprises a second step of determining a ratio between a maximum average length zₘₐₓ and a minimum average length z ₘᵢₙ.

In this regard, the second step comprises the determination of average lengths z ᵢ sweeping the first section 11 at any point i of the periphery 11.1 of said section 11.

Indeed, each of the average lengths z ᵢ corresponds to an average length z ᵢ of rays z_{i,α} extending completely in the first section 11 from a point i at the periphery 11.1 and sweeping said section 11. Preferably, the rays z _{i, α} correspond to projections of point i over an entire portion of the periphery 11.1 which is facing said point i.

Determining the maximum average length Z ₘₐₓ and minimum z ₘᵢₙ requires determining the average length zᵢ for each of the points i over the entire periphery 11.1. Preferably, such a determination is an automated process using a computer algorithm. In this regard, an algorithm applying a method of the type: “ray tracing” can be adapted, the latter being also known by the English name “ray tracing”.

Advantageously, the inventors have wisely adopted an innovative approach by introducing the ray tracing technique, which is until now unknown in the field of mechanics. They realized that this is the optimal way to characterize this section in order to size it in such a way as to optimize orbital welding and thus reduce the presence of contaminants in the weld. This method will be detailed later in this description.

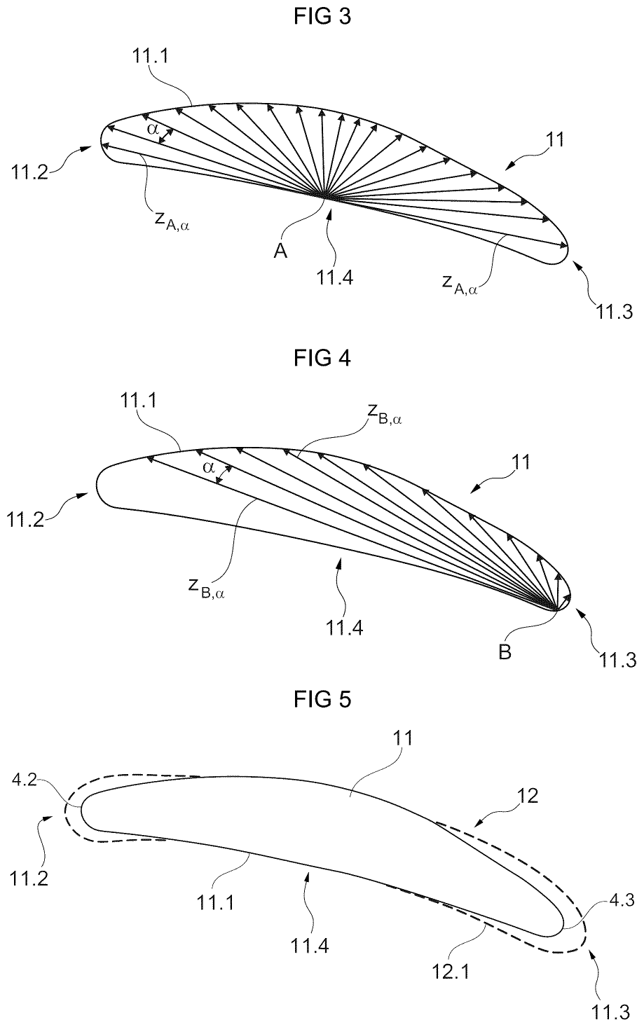

FIGS. 3 and 4 illustrate an example of projection of rays z _{A,α} and Z _{B,α}, respectively, from points A and B of the periphery 11.1.

The ray tracing method on section 11 can be performed using the following steps:
model a first section 11 (visible in FIG. 2) based on the final aerodynamic profile 4.1 of the blade with the addition of the extra thickness e (which shares the same value as that of the eccentric which is planned to be applied to the tool during orbital welding); And
divide the periphery 11.1 into several points i from which the rays z _{i, α} will be projected, preferably at approximately 2000 points distributed homogeneously (this number may vary depending on the desired calculation precision); And
project rays z _{i, α} which sweep (scan) the entire section 11 from a first point i of the periphery 11.1, the number of projected rays z _{i, α} depends preferentially on an angle α of between 0.001° and 10°; And
measure the average length z ᵢ of all the rays z _{i, α} projected from the first point i; and
repeat the step of projecting the rays z _{i, α} as well as that of measuring the average length z ᵢ, successively for all points i of the periphery 11.1; And
evaluate all the average lengths z ᵢ measured from all points i to determine the maximum average length z ₘₐₓ and the minimum average length z ₘᵢₙ.

The two points A and B were determined using the ray tracing method described above, they correspond to the two points which made it possible, respectively, to find the maximum average length z ₘₐₓ and the minimum average length z ₘᵢₙ, and this, after having swept the section 11 with rays z _{i, a} from all the points i of its periphery 11.1.

FIG. 3 illustrates the first modeled section 11 of FIG. 2 during a determination of an average length z _{A} of rays z _{A, α} sweeping said section 11 from a point A of the periphery 11.1.

It can be seen that point A is arranged at a central portion of section 11 at a distance from two ends 11.2, 11.3 of said section 11, along a chord of the corresponding blade, and corresponding respectively to an edge d attack 4.2 and a trailing edge 4.3 (visible in FIG. 2) of said corresponding blade.

From point A, a plurality of rays z _{A, α} are projected onto a portion of the periphery 11.1 visible from said point A. In this configuration, the rays z _{A, α} can be included between two extreme rays z_{A, α} which are tangent to the periphery 11.1.

The number of projected rays z _{A, α} can depend on the angle α chosen, the latter makes it possible to establish the precision of determination of the average rays z_{A}. For this purpose, the angle α can be between 0.001° and 10°. Preferably, the angle α is identical for all the projections of the rays z _{i, α} for the plurality of points i of the periphery 11.1.

The average length z_{A} thus corresponds to the average of all the projections z_{A, α}. In this configuration, the average length z_{A} can, for example, correspond to the maximum average length zₘₐₓ.

FIG. 4 illustrates the first modeled section 11 of FIG. 2 during a determination of an average length z _{B} of rays z _{B, α} sweeping said section 11 from a point B of the periphery 11.1.

Similarly to point A, the rays Z _{B, α} are projected from point B onto a portion of the periphery 11.1 visible to said point B. Thus, the average length z e corresponds to the average of all the projections Z _{B, α}.

For example, the average length z _{B} may correspond to the minimum average length z ₘᵢₙ. It should be noted that although point B is illustrated as being located at end 11.3 of section 11, this can also be located at end 11.2 and give rise to a maximum average length.

If the ratio of the maximum average length Z ₘₐₓ to the minimum average length z ₘᵢₙ is less than or equal to 2, then the first modeled section 11 corresponds to the junction section S (visible in FIG. 1) which will be used during orbital welding of the blade to the stub. Alternatively, if the ratio of average lengths (zₘₐₓ/zₘᵢₙ) is greater than 2, then a third step of the stub dimensioning process is carried out, said third step comprising an enlargement of the modeled section 11, so as to respect the ratio: zₘₐₓ/zₘᵢₙ≤2.

Advantageously, the inventors have discovered that by respecting a ratio between Z ₘₐₓ and z ₘᵢₙ which is less than or equal to 2, and preferably less than or equal to 1.8, and even more preferably less than or equal to 1.5, the weld between the blade and the stub has better structural quality, free of contaminants and recesses. Indeed, the determination of the average lengths z ᵢ, passing through the projected rays z _{i,α}, to respect the ratio zₘₐₓ/zₘᵢₙ<2, makes it possible to limit in a relevant manner the presence of too great a concavity at the level of the section to be welded which may negatively affect the orbital welding operation. Advantageously, respecting said ratio makes it possible to have an ideal camber of the junction section making it possible to obtain a homogeneous and solid weld, while limiting the risks of recirculation of material during the orbital movement and therefore the poor ejection of contaminants. generated at the start of the welding phase.

Furthermore, the determination and respect of such a ratio is particularly relevant for sections to be welded by orbital friction, because each of the surfaces of section 11 comprising the projected rays z _{i, α} from each point i can be assimilated to material kneading surfaces during orbital friction welding.

Indeed, the friction force provided during welding rotates cyclically, which implies that a welding point at the end of section 11 of the stub (eg. point A or B) sees a fraction of section 11 of the blade between the two extreme projected rays (z _{A, α} or z_{B, α}), the latter can therefore be assimilated to equivalent lengths of material to be sheared.

In this regard, the widening of the modeled section 11 opts to reduce the maximum average length Z ₘₐₓ and/or to increase the minimum average length z ₘᵢₙ.

FIG. 5 illustrates a second modeled section 12 resulting from an enlargement of the first modeled section 11 of FIG. 3.

In this configuration, we seek to increase the minimum average length z ₘᵢₙ, which amounts to increasing the value of the average length z_{B}. For this purpose, the widening of the first section 11 comprises the addition of a second extra thickness, at the level of at least one of the two ends 11.2 and 11.3 of said section 11 comprising the point B from which the minimum average length z ₘᵢₙ was determined.

The enlargement can be carried out manually using modeling software, or automatically by a specific computer algorithm.

After widening, the stub sizing method of the invention provides for repeating the second step in order to redetermine average lengths z ᵢ sweeping the second section 12 at any point i of its periphery 12.1. If the ratio: zₘₐₓ/zₘᵢₙ≤2 is respected, then the second section 12 will be the junction section used for orbital welding. Otherwise, a third section will be modeled so as to shape the extra thickness d, i.e. reduce or increase the latter, and/or add a third extra thickness in order to respect the ratio between zₘₐₓ and zₘᵢₙ. It should be noted that different attempts may be necessary before being able to model the junction section respecting the ratio. Thus, the second and third steps of the process can be carried out iteratively.

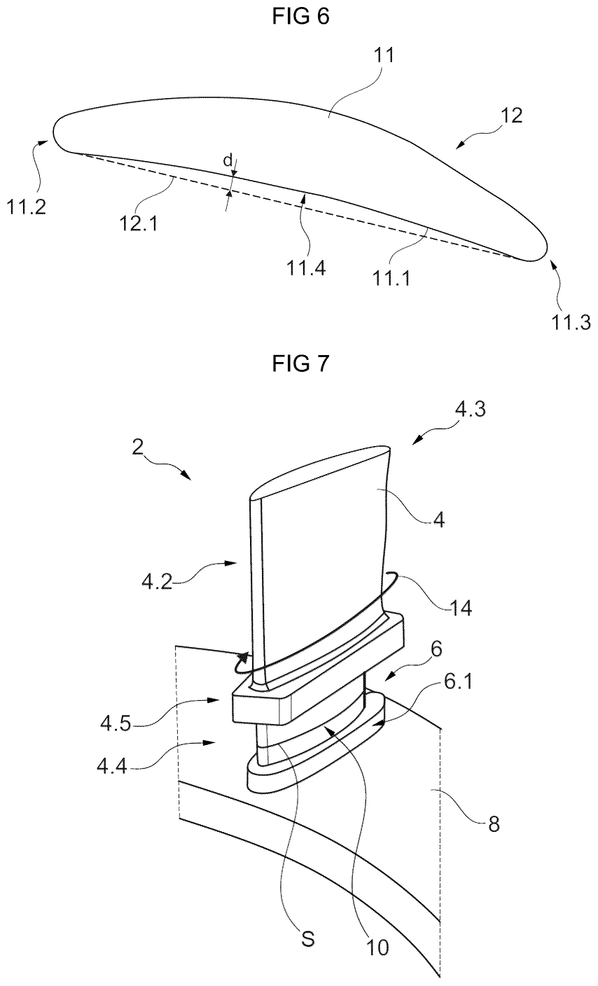

Alternatively, and depending on the profile of the modeled section, the average length z _{A} measured from the projections z _{A,α} of point A in FIG. 3, can, for example, correspond to the minimum average length z ₘᵢₙ, and the average length z _{B} measured from the projections z _{B,α} of point B in FIG. 4, can, for example, correspond to the maximum average length z ₘₐₓ. For this purpose, and as illustrated in FIG. 6, the second extra thickness d can be added at the level of a concave portion 11.4 of section 11, instead of the two ends 11.2 and 11.3.

It should be noted that the present invention is not limited to the examples illustrated. Indeed, the minimum and maximum average lengths can be relative to different points at points A and B illustrated in FIGS. 3 and 4, points which can change with each enlargement of the section.

FIG. 7 schematically represents a perspective view, during orbital friction welding, of the blade to the disk stub, by means of the junction section.

Preferably, the blade 4 comprises to the right of its lower end 4.4 a reinforcement 4.5 which will be machined after the welding operation together with a volume 6.1 for reinforcing the stub 6 on the disc 2.

Prior to orbital friction welding by means of an orbital oscillation movement 14, a sacrificial volume of material (extending essentially radially) is provided on each of the blades 4 and the stubs 6 to be assembled. This sacrificial volume is caused to be expelled outside a junction 10 corresponding to the contact interface between the two junction sections S, thus forming a burr, commonly designated by: “flash”, which will then be eliminated, preferably, by machining, in order to arrive at the final section (corresponding to aerodynamic profile 4.1 visible in FIG. 2) to form the blisk.

However, in the case where state-of-the-art stubs comprise non-dimensioned sections according to the method of the invention, the flash risks causing a recirculation of material inside the regions of said most sections. narrow and risks creating recesses in the welded joint, which affects the quality of the weld.

Advantageously, the dimensioning of the junction section S respecting the ratio of the maximum average length z ₘₐₓ to the minimum average length z ₘᵢₙ which is less than or equal to 2, in particular following a widening compared to the final section, makes it possible to enlarge the contact surface during orbital friction welding so as to ensure thermal homogeneity during welding, precisely in the final section 4.1 of blade 4. In fact, if we add an extra thickness e to minimum equal to the value of the eccentric, this means that the points of the final aerodynamic surface 4.1 are always in contact during the weld (between the two stubs). Unlike the points in this extra thickness e which, through the orbital movement, are only in contact with the opposite surface during part of the orbital oscillation movement.

Thus, during welding, a material consumption rate remains constant at the junction section S, which makes it possible to avoid the recirculation of the material (potentially harmful because it prevents the evacuation of impurities) at the level of the section of the final aerodynamic profile 4.1 of the blade and thus allow homogeneity and continuity of the mixing of the material of the stub with that of the blade making it possible to further preserve the aerodynamic profile of the blade and to obtain a strong junction.

Preferably, the junction section S of each of the blades 4 and stub 6 comprises a total surface area greater than or equal to 200 mm² and less than or equal to 7000 mm², and more preferably between 2000 mm² and 3000 mm².

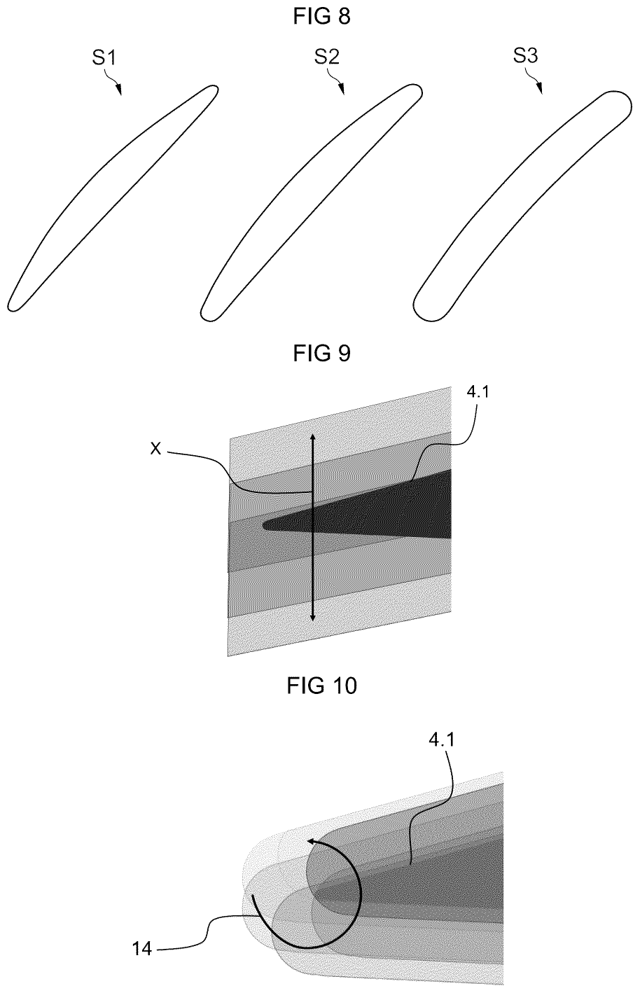

FIG. 8 represents several stub geometries S1, S2 and S3 built around an aerodynamic profile of a blade which is not shown. The sections S1, S2, S3 preferably all have the same area value in mm². The objective of this comparison is to show that for profiles presenting zₘₐₓ/zₘᵢₙ ratios above or meeting the criterion (less than or equal to 2), the contaminants created in the very first phase of the orbital weld are evacuated with more or less effectiveness. This will be explained further following Table 1 below.

FIG. 9 represents the relative movements of the sections to be welded corresponding to the state of the prior art (linear welding) in a direction X perpendicular to the chord of the blade profile.

The section of the prior art corresponds here to a section as proposed by the published patent document EP 1 495 829 A1, i.e. in which each end of the front and rear edge zone comprises an excess of material which ends with a straight edge aligned parallel to the oscillation direction X.

FIG. 10 represents relative movements of two sections according to the invention during orbital friction welding. This figure schematizes the fundamental difference with the prior art (linear friction) and allows a better understanding of the relative movements of the two sections to be welded in the context of an orbital weld.

TABLE 1

| | S0 | S1 | S2 | S3 | Circle |
|---|---|---|---|---|---|
| zₘₐₓ/zₘᵢₙ | 2.15 | 1.94 | 1.73 | 1.53 | 1 |
| Prior art (wₘₐₓ/ | 5.64 | 3.02 | 1.94 | 1 | |
| wₘᵢₙ) | | | | | |
| Weld condition | NOK | OK | OK | OK | OK |

FIG. 8 illustrates sections S1, S2 and S3 of table 1 which gives the values of zₘₐₓ/zₘᵢₙ.

The ratio w ₘₐₓ/w ₘᵢₙ of the prior art corresponds here to a criterion set out in the published patent document EP 1 495 829 A1, ie including in particular a stub section having a ratio of the widest part (width w ₘₐₓ) on the narrowest part (width w min) which is less than 2.

An “OK” qualified weld condition indicates a sound, contaminant-free weld, while a “NOK” condition corresponds to a weld containing contaminants that have not been flushed from the joint during orbital friction.

It can be seen from the table that sections S1, S2 and S3 having a ratio zₘₐₓ/zₘᵢₙ less than 2, make it possible to obtain a welded junction whose health status is “OK”, while section S0 (not illustrated) whose ratio z ₘₐₓ/z ₘᵢₙ is less than 2, leads to a state of the welded junction qualified as non-compliant “NOK”.

In the case of section S1, we can see that the criterion (wₘₐₓ/wₘᵢₙ<2) established by the prior art is not respected and nevertheless provides a compliant weld. In fact, the section of the prior art is not suitable for orbital welding. This can in particular be explained by the fact that the widths taken into account in the measurement of the width ratio proposed by document EP 1 495 829 A1, were measured in a direction of linear friction (direction X in FIG. 9). However, orbital welding is not limited to a single direction of linear friction, but rather encompasses all directions, because the mixing of material is done 360° in orbital welding. In general, it is important to note that a configuration where two sections to be welded have a perfect circle shape allows for optimal orbital welding. This configuration ensures perfectly homogeneous and constant mixing, which guarantees a stable temperature rise of the materials. In addition, the circular shape of the sections allows uniformity of friction over 360°, without changing shape. The circular shape cannot be calculated with the criterion of the prior art.

The inventors took the inventive step of introducing the ray tracing method described above, an unconventional technique in the field of mechanics, to characterize the junction section in order to take into consideration all directions friction. Indeed, the sweeping of the section with rays z _{i, α} launched from each of all the points i of its periphery, is similar to the movements of mixing of material between the surfaces in contact during orbital welding, said movement being following all directions and 360°.

The inventors subsequently determined that when the ratio Z max/Z min is less than or equal to 2, possible stress zones in the shape of the section which can cause recirculation of material in the weld are avoided. intrinsically.

Advantageously, the ratio z ₘₐₓ/z ₘᵢₙ less than or equal to 2 makes it possible to obtain a general shape of the junction section which guarantees an “OK” weld state.

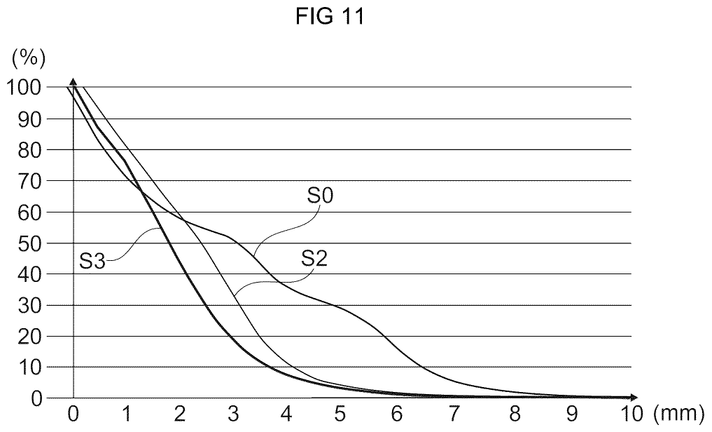

FIG. 11 represents the ejection speed of the first layers of material in contact and thus expresses the ejection speed of the contaminants. The abscissa axis represents a standardized value of material consumption (in mm) and the ordinate axis represents the % of material of the layers in initial contact during welding (which can be compared to a % of contaminants on the surface). This result is obtained by numerical simulation.

We can see a plot for each of the three junction sections S0, S2 and S3.

The welds were carried out on the same machine and with constant welding parameters, ie eccentricity, oscillation frequency, speed and forging pressure which remain unchanged, only the shape of the sections is modified.

A greater speed of ejection of contaminants is observed when the sections are sized according to the method of the invention with a ratio zₘₐₓ/zₘᵢₙ less than or equal to 2, while the presence of contaminants persists longer when the ratio exceeds 2.

In fact, sections S2 and S3 meeting the criterion according to the invention require a material consumption (of the two welded stubs) of less than 7 mm in order to remove all contaminants from the weld. The S0 section, on the other hand, requires a material consumption of more than 9 mm, and cannot remove all contaminants.

Advantageously, orbital friction welding of two identical sections S2 (having a ratio zₘₐₓ/zₘᵢₙ equal to 1.73), makes it possible to obtain an optimal weld, because the remaining contaminant particles escape quickly and in large quantities, resulting with low material consumption and a welded junction free of contaminants. The observation is the same for welding two identical S3 sections (having a ratio equal to 1.53).

Whereas an orbital welding of two S0 sections (having a ratio of 2.15), does not allow all the contaminants to be evacuated with the same speed, and therefore requires a large consumption of material to be able to evacuate the remaining particles.

Thus, when the ratio z ₘₐₓ/z ₘᵢₙ is less than or equal to 2, contaminants escape quickly from the welded junction and in large quantities, resulting in reduced material consumption. Consequently, the volume of sacrificial material necessary between the blade and the disk can be considerably minimized when the junction section is dimensioned according to the invention.

1.-15. (canceled)

16. A method for sizing a section of a junction by orbital friction welding between a blade and a stub of a bladed disk for a turbomachine, wherein the section is sized so that a ratio between an average length of rays extending completely in the section from a point at a periphery of said section and sweeping said section, wherein said average ray length is a maximum average length, and an average ray length extending completely in the section from another point at the periphery of said section and sweeping said section, wherein said average length is a minimum average length, is less than or equal to 2.

17. The method according to claim 16, wherein the other point at the periphery of the section where the average length of rays is maximum z ₘₐₓ is located at a distance from two ends of the section, along a chord of the corresponding blade, and corresponding to a leading edge and a trailing edge of said corresponding blade.

18. The method according to claim 16, wherein the point at the periphery of the section where the average length of rays is minimum average length is located at one end of the section, along a chord of the corresponding blade and corresponding to a leading edge or a trailing edge of said corresponding blade.

19. The method according to claim 16, wherein the section of the stubs at the junction with the blades is sized by widening said section in relation to a final section after joining the blades and machining.

20. The method according to claim 19, wherein the section of the stubs at the junction with the blades is widened relative to the final section at at least one of the two ends of the section.

21. The method according to claim 16, wherein the sizing of the section of the stubs at the junction with the blades includes a calculation of the average length of rays for a series of points distributed along the periphery, respectively and a determination of the maximum average ray length and the minimum average ray length among the average ray lengths of the series of points.

22. The method according to claim 16, wherein the sizing of the section of the stubs at the junction with the blades comprises a determination of the maximum average length of rays and the minimum average length of rays for different sections, iteratively.

23. A method for manufacturing a bladed turbomachine disk, comprising the following steps:
provision of a disc with stubs; and
joining of blades to the stubs by orbital friction welding, wherein the stubs of the disc are sized according to a method for sizing a section of a junction by orbital friction welding between the blade and the stub of a bladed disk for a turbomachine, wherein the section is sized so that a ratio between an average length of rays extending completely in the section from a point at the periphery of said section and sweeping said section, wherein said average ray length is a maximum average length, and an average ray length extending completely in the section from another point at the periphery of said section and sweeping said section, wherein said average length is a minimum average length, is less than or equal to 2.

24. The method according to claim 23, further comprising:
sizing the stubs by widening the section in relation to a final section after joining the blades and machining; and
machining of the stubs and the blades joined to the stubs so as to remove the widening and arrive at the final blade section.

25. A rotor disk for a manufacture of a bladed disk for a turbomachine, the rotor disk comprising an external surface provided with an annular row of stubs extending radially from said external surface, each of the stubs comprising a section to be welded by orbital friction with a blade, wherein said stubs are sized according to a method for sizing a section of a junction by orbital friction welding between a blade and a stub of a bladed disk for a turbomachine, wherein the section is sized so that a ratio between an average length of rays extending completely in the section from a point at the periphery of said section and sweeping said section, wherein said average ray length is a maximum average length, and an average ray length extending completely in the section from another point at the periphery of said section and sweeping said section, wherein said average length is a minimum average length, is less than or equal to 2.

26. The rotor disk according to claim 25, wherein the section is between 200 mm² and 7000 mm².

27. The rotor disk according to claim 25, wherein the section is between 2000 mm² and 3000 mm².

28. The method according to claim 23, further comprising:
sizing the stubs by widening relative to the final section at at least one of the two ends of the section; and
machining of the stubs and the blades joined to the stubs so as to remove the widening and arrive at the final blade section.
